(19) United States
(12) Patent Application Publication
(10) Pub. No.: US 2015/0066444 A1
(43) Pub. Date: Mar. 5, 2015

(54) USER INTERFACE AND SOFTWARE TOOL FOR ARCHITECTURAL PROCESSES

(71) Applicant: Archetris, Inc., Sebastopol, CA (US)

(72) Inventors: Bryan Almquist, Occidental, CA (US); Daniel Sudol, Westport, CT (US); Jules Brenner, Novato, CA (US)

(73) Assignee: ARCHETRIS, INC., Sebastopol, CA (US)

(21) Appl. No.: 14/473,467

(22) Filed: Aug. 29, 2014

Related U.S. Application Data
(60) Provisional application No. 61/871,806, filed on Aug. 29, 2013.

(51) Int. Cl. G06F 17/50

(52) U.S. Cl. CPC G06F 17/5004
USPC 703/1

(57) ABSTRACT

A novel software architectural design tool allows users to perform stacking, block editing, and scaling in an efficient and intuitive manner. The user selects a resource from a resource pool, such as number of employees and square footage organized by department, displayed on a monitor. A portion of the resources are allocated to a stacking diagram using a visually intuitive interface. The stacking diagram includes bar graphs, each one representing, for example, a floor in a building. The resource pool and the stacking diagram are modified graphically and in real time. For block editing, the user bifurcates an edge of the object by selecting an edit point. In a second step, the user can edit the edge utilizing the edit point. Block editing becomes an efficient and visually intuitive process which is also in line with thought processes inherent in architectural training.

### CROSS-REFERENCE TO RELATED APPLICATIONS

This application claims priority under U.S.C. §119(e) to pending U.S. Provisional Application No. 61/871, 806, filed Aug. 29, 2013, entitled “Method and System for Automating Architecture Processes” by Almquist et al., hereby incorporated by reference in its entirety.

### BACKGROUND OF THE INVENTION

1. Field of the Invention

The present invention relates to software for architectural processes. More specifically, the software is for the Programming and Schematic Design stages in the development process.

2. Description of the Related Art

Architectural projects have long used software tools to facilitate the processes architects go through to complete a project or get it ready for presentation to clients. Typically, such projects go through a sequence of stages. For example, a common sequence is Programming>Schematic Design>Design Development>Construction Documentation>Bid Negotiation>Construction Administration Almost all of the conventional architecture-specific software applications are focused on Design Development and Construction Documentation.

However, early stages of the architectural process, such as Programming and Schematic Design, often benefit from the use of software tools as well, but there are few tools specifically designed for them. Within Schematic Design, there are typically four tasks which are often re-iterated or gone through multiple times in the same project: Stacking, Blocking, Planning and Analysis. The most common software tools used to support these tasks are non-architecture specific (e.g., Microsoft Excel, Adobe Photoshop or Illustrator) or not specific to early-stage design work (e.g., Autodesk AutoCAD, Revit). Because these tools are generic and do not interoperate or have compatible interfaces, a workflow comprised of them requires significant re-entering of information; that is, data output from one program needs to be manually entered as input to another. Furthermore, these tools, being generic and re-purposed for the architectural process, are not optimized for Schematic Design or any of the other architectural stages.

Presently, architects use various general-purpose software tools, such as spreadsheets, graphics programs, and drawing tools to create Design documents which are shown to clients. This patchwork of software is ill-suited for Schematic Design and Programming (as well as for other stages). For example, a spreadsheet program such as Microsoft Excel may be used in the Programming stage to present and store data in a tabular format. The same program may also be used for another early stage known as Stacking, part of Schematic Design. Once the data is in a tabular format, a graphics tool, such as AutoCAD, maybe used to create the images or drawings. The output of these graphics programs may then be edited using an illustration program, such as Photoshop or Illustrator, to create suitable graphics for client presentation. These are a few common examples; there are other programs used as well, all from different vendors and each requiring input data in a certain format and each outputting data in various manners.

Architects and their technical staff have over time proven to be adept at using this patchwork of general-purpose programs. However, there is still significant time and resources wasted in using such software, even for proficient users. For example, there is often significant data entry required because data does not flow seamlessly from one program to another (e.g., data in tabular form in a spreadsheet does not transition automatically to an AutoCAD program, or from there to a graphics editing program, and so on).

In addition, because disparate tools are used in the early and most abstract stages of the architectural process, specific customizations or “tweaks” are often made by architects to the programs and output. As a consequence, it is difficult to examine results across multiple projects, for instance, to study trends or make extrapolations from projects that are similar.

It would be desirable to have a single, comprehensive software tool that focuses on the Programming and Schematic Design stages of the architectural process and its re-iterative approach. The tool should have workflows, data transitions, and a user experience that are in line with how architects are mentally and professionally trained to approach and think about a project, moving from the spatially abstract to the spatially definite.

### SUMMARY OF THE INVENTION

In one aspect of the present invention, a method of using a novel software architectural design tool is described. In one embodiment, the tool is used in the schematic design phase of an architecture project, but may also be used in other contexts. One stage in schematic design in which the tool can be used is stacking. Here the user selects a resource from a resource pool, such as number of employees and square footage organized by department, displayed on a monitor of a computing device. A portion of the resources are allocated to a stacking diagram using a visually intuitive interface. In one embodiment, the stacking diagram includes a plurality of bar graphs, each one representing, for example, a floor in a building. Upon the user completing an allocation, the resource pool and the stacking diagram are modified graphically and in real time. The tool also allows the user to block edit a graphical object in an intuitive and efficient manner. A graphical object is selected and brought onto a working canvas. The user can bifurcate an edge of the object by selecting an edit point along the edge. Two and three dimensional objects, such as planar surfaces or objects, can also be edited using the same process. Bifurcating an edge or other component of the object can be done in one step by the user. In a second step, the user can edit the edge (or other component of the object) utilizing an edit point. In this manner, block editing a graphical object becomes efficient and visually intuitive process which is also in line with thought processes inherent in architectural training.

### BRIEF DESCRIPTION OF THE DRAWINGS

References are made to the accompanying drawings, which form a part of the description and in which are shown, by way of illustration, specific embodiments of the present invention:

FIG. 1 is a screen shot showing an example of stacking in accordance with one embodiment;

FIGS. 2A to 2E illustrate block editing features in accordance with one embodiment of the present invention;

FIGS. 3A to 3C are portions of screen shots showing a process of scaling a background image upon importing the image onto a canvas in accordance with one embodiment;

FIG. 4 is an illustration of a background image to be imported onto a canvas in accordance with one embodiment; and

FIGS. 5A and 5B are block diagrams of a computing system suitable for implementing various embodiments of the present invention.

### DETAILED DESCRIPTION OF THE INVENTION

Example embodiments of software tools for architecture processes are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Before describing the figures showing various embodiments of the present invention, it is helpful to briefly describe two of the early stages of the architectural processes noted above. The Programming stage may be described as creating specifications for a project. It involves addressing issues related to the functional requirements of a building such as hierarchical organization of people and spaces; quantity of people and spaces; furniture, fixtures and equipment required for the stated function; and other factors (it typically does not address what the building may look like).

Another early stage of the process and one that is relevant to the present invention is Schematic Design. This stage may be described as optimizing the arrangement of the spaces identified in Programming It involves addressing issues of adjacency (which groups of people or spaces should or should not be in close proximity to others) and the shape of the groups and spaces as they relate to each other and the building. Schematic Design takes into consideration the building's shape, but not the aesthetics of the building. Concepts described herein are applicable to interactive component construction and design generally. The described embodiment illustrates how the tool is used for Schematic Design.

As noted above, Schematic Design includes sub-stages, some of which are iterative, during a project: stacking, block editing, planning, and analysis. One tool that is used throughout, especially during blocking, is scaling where a user is able to set a scale for a graphical representation of a background element. As described below, the user is able to click on portions of the background element/graphical representation, move the element onto a canvas having known dimension and that may contain other graphical elements, and ensure that n feet of the element represents n feet in the canvas with respect to the canvas dimensions and with other graphical elements. Blocking, scaling of background elements and other processes are worked on in a canvas shown in the display. In other embodiments, the scaling techniques and user experience described herein may be used to graphically edit objects in other types of applications and tools, outside of the architecture space.

Methods and systems for software and user interfaces related to various stages of Schematic Design in the architectural process are described in the various figures. In one embodiment of the present invention, these methods and systems are implemented as software executing on computing devices, such as personal computers, tablets, or other mobile devices, such as smart phones.

One characteristic of the software program of the present invention is its ability to seamlessly transition data through a series of logical steps. This provides a more manageable way to work with the data, clarifying relationships with each other (i.e., where does the data belong in relation with each of the steps such as stacking and blocking), and not solely focusing on specific aspects of the data, as what often occurs when using general-purpose software tools.

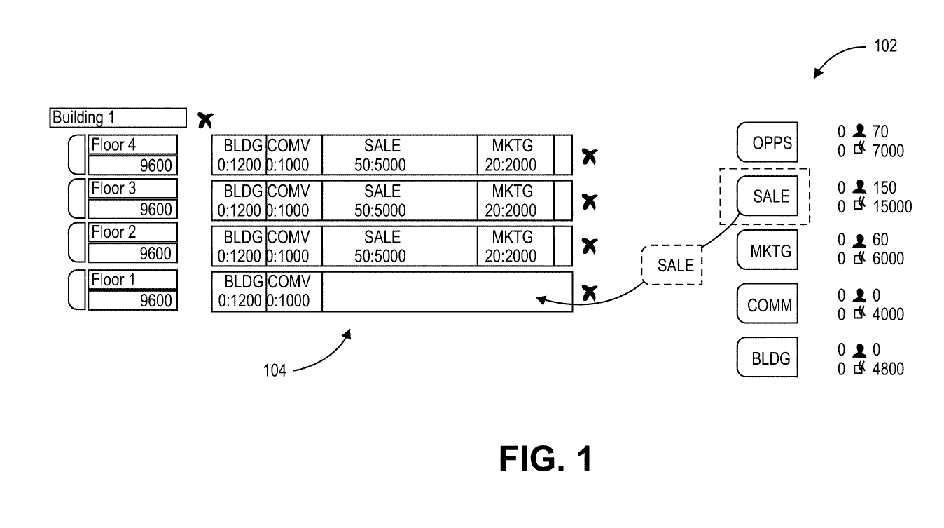

In one embodiment, a stage in Schematic Design, referred to as stacking, enables a user to assign, for example, the location of groups across buildings and floors through a graphical interface. At this stage, for example, spaces in a floor plan are placed next to each other in a horizontal bar graph (20% of floor 1 is Dept. 1, 35% of floor 2 is Dept. 2, and so on). FIG. 1 illustrates one example of stacking, in annotated form, for a particular project. Current (conventional) methods do not provide for Stacking as a design tool; they are limited to only reporting on the design. After Stacking, the user is able to execute functions related to blocking of a floor plan.

FIG. 1 is a block diagram illustrating stacking in accordance with one embodiment. Stacking, one stage of Schematic Design, is often an iterative process and is well suited for conveying visually. As one feature of the software tool of the present invention, the stacking user interface offers rapid and accurate design with real-time feedback of visual elements and of design-related data in the working canvas. With respect to stacking, in one embodiment, the user defines two primary components: a resource pool (feeder component) 102 and a stacking diagram (receiver component) 104. Resources are taken from resource pool 102 and allocated to a specific floor in the stacking diagram 104. In one example, stacking diagram 104 has four horizontal bars each representing a floor used for allocating project resources. The stacking operation occurs when a user takes resources from pool 102 and “drags” it into one of the floor bar graphs, thereby changing the percentage of occupancy for that floor and providing an immediate visual indication to the user of the department adjacencies throughout the project. This is shown as item 106 representing Sales employees moved from pool (feeder component) 102 to a specific floor in the stacking diagram (receiver component) 104. At the same time the specific resource pool quantities are modified to reflect the unallocated head count and square footage for that specific department. Resource quantities assigned to a floor can be edited by dragging an edge to resize the representative graphic. The stacking shown in FIG. 1 is in a format suitable for analysis and planning for subsequent steps in the architectural design lifecycle.

Each horizontal bar (representing a floor in this embodiment) may be freely arranged and grouped by the user and may be assigned customized properties. For example, a property may be a “square footage limit” provision which states the maximum space available for allocation on a given floor.

The software tool and user interfaces of the present invention can accommodate changing environments of a project. For example, as the size of a project increases (e.g., by total square footage or increasing personnel), conventionally, using general-purpose software, the processes described above becomes increasingly difficult. For example, adding one more employee or increasing the square footage by a small percentage, has ramifications and negative downstream effects on design and outputs of the system. Optimization and modification of floor allocations, such as re-arranging, adding, or removing resources, can be difficult and become error-prone. The feeder and receiver components of the present invention provide useful visual aids and real-time updates to simplify the design process.

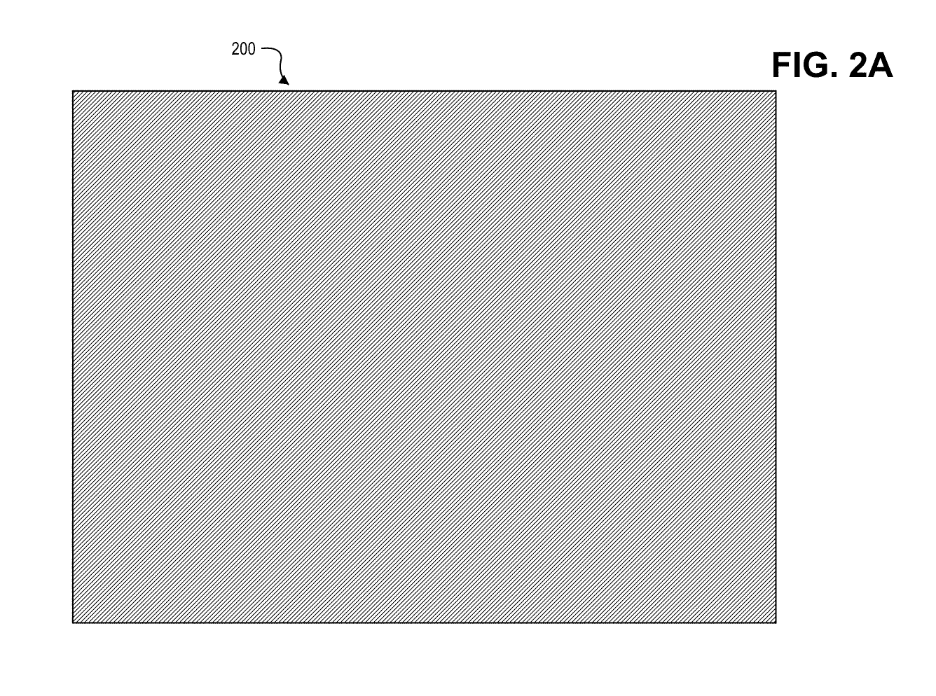

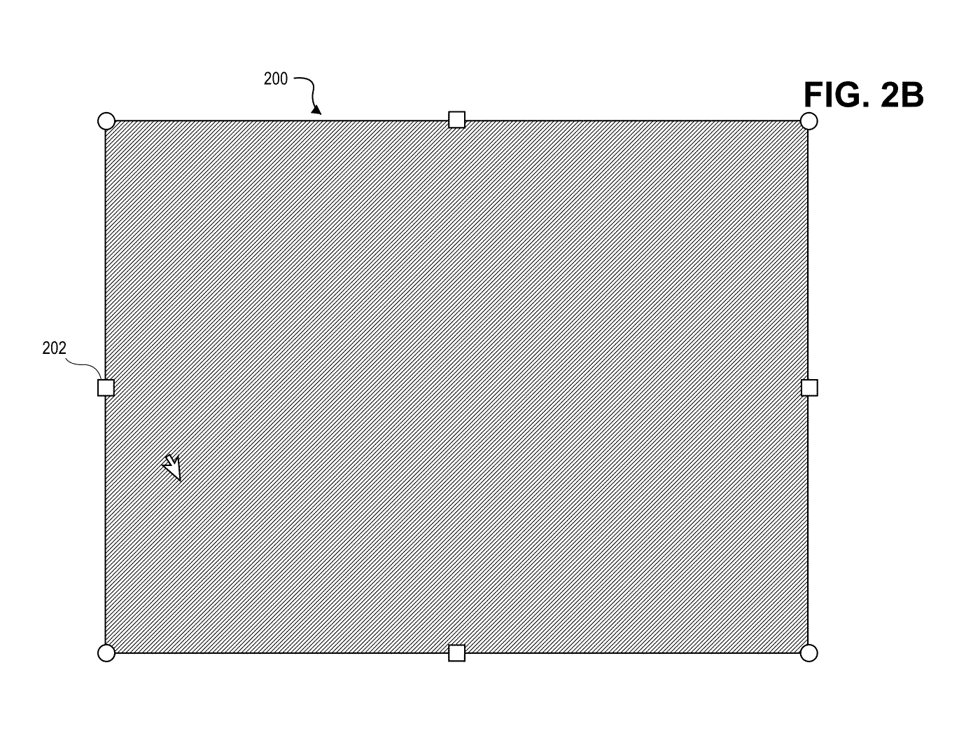

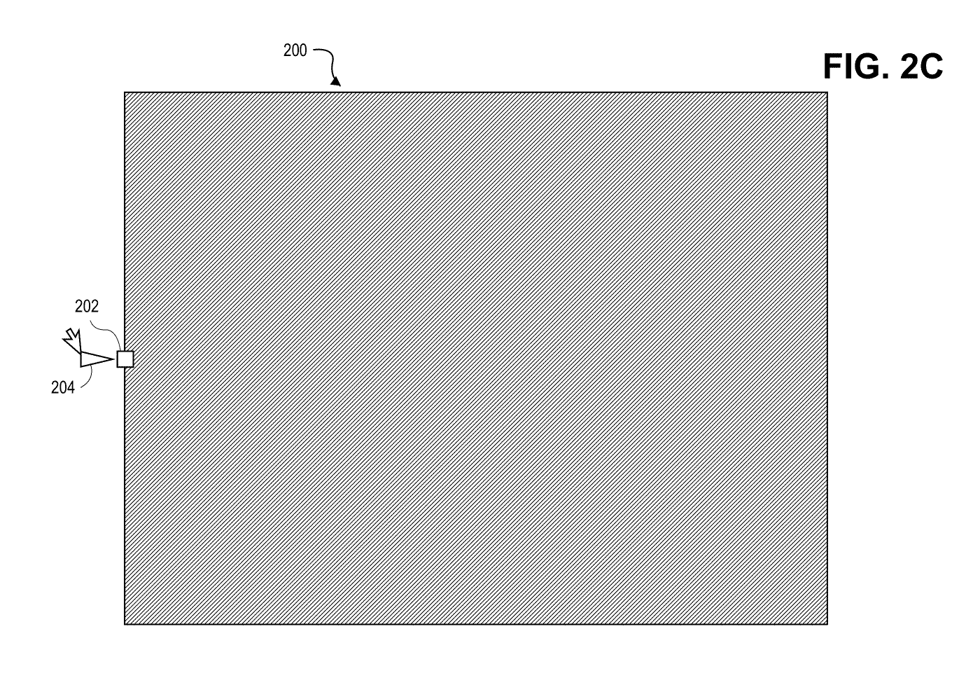

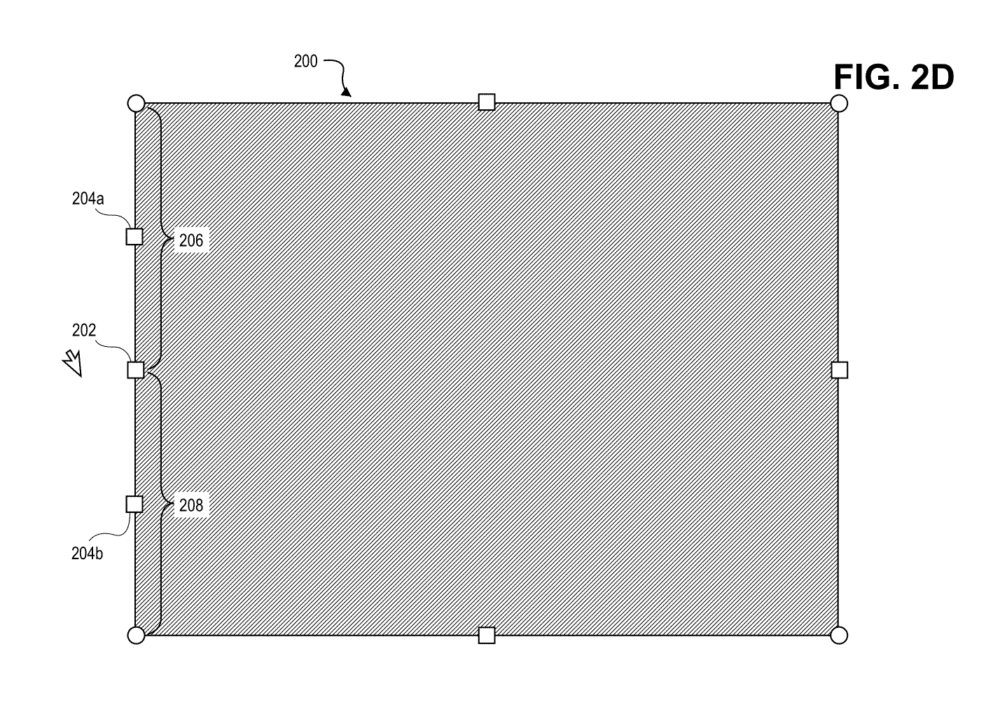

Another stage in Schematic Design is block editing. In one embodiment, block editing occurs over several steps. Screen diagrams showing the user experience are shown in FIGS. 2A to 2E illustrating blocking features in accordance with one embodiment of the present invention. FIG. 2A shows a graphical element 200 on a canvas as displayed in one of the user interfaces of the present invention. There may be other graphical objects on the canvas. The user is able to graphically edit or block edit element 200 which may represent, for example, a department on a floor of a building. Typically, the user selects a simple graphical object and edits it to create a complex object for a specific architecture project.

FIG. 2B is a screen shot of the user having selected graphical object 200 on the canvas for editing. This may be done by clicking anywhere on the object. Once object 200 has been selected, specific points along its perimeter are marked by edit points, such as intersection points shown by the circles and edge points represented by the squares. In one embodiment, the edge edit points bifurcate the edges of object 200.

At FIG. 2C, the user selects an edit point. In this illustration, the user selects edit point 202 on the left edge of object 200. Once an edit point is selected, in one embodiment, the other edit points are no longer displayed. A splitter 204 appears next to the selected edit point as shown in FIG. 2C. In FIG. 2D, the user has selected splitter 204 at which stage it is no longer displayed. By selecting splitter 204, the user has now bifurcated the edge represented by edge point 202; the user wants to edit that edge of object 200. The edge is now comprised of two lines or bifurcated edges that can be moved and edited independently: section edge 206 and section edge 208. Each edge now has its own edit point, 204a for line 206 and 204b for line 208. This same process can be done on any of the other edges and edits points of object 200.

In FIG. 2E the user selected edit point 204b for bifurcated edge 208 and moved the line to the right making the first edit to graphical object 200. In one embodiment, edit points are not displayed when the user performs the actual editing of an object, such as moving an edge. After the editing is done, the edit points are displayed again including new ones as a result of the editing, as shown in FIG. 2E. Here a new edit point 212 has appeared representing a new edge resulting from moving edge 208. In other embodiments, placement of edit points may change after edits or placement may depend on the complexity of the previous edits. The user may continue editing object 200 to form a more complex object. For example, the user may select new edit point 212 and move it up or down, repeating steps shown in FIGS. 2A to 2E.

As shown in the block editing figures, after a graphical element is inserted or dropped onto a design or working canvas, it can be immediately edited by the user using various user interfaces and interactions—free of menus or command executions—using single-click controls. With these controls, a user can stretch an element, break a component/edge into child edges (e.g., 206 and 208), modify the child components, merge them into a new edge, and automatically update related data, such as area, perimeter, and associated metadata (not shown in FIGS. 2A to 2E).

The steps described above for block editing may be applied to editing other types of objects. The illustration shows editing an edge, a one dimensional object, to change the shape of a graphical object. The same process of using a splitter and edit points can be used to edit two dimensional objects, namely, planar surfaces and three dimensional objects such as solid shapes. The process of block editing generally is not limited to editing one dimensional objects as illustrated in FIGS. 2A to 2E which shows one embodiment.

In another aspect of the present invention, the software functionality enables scaling that can be used to scale a background image (e.g., a raster or vector graphic). As is known in the art, determining a scale factor in the schematic design stage can be a difficult and time-consuming task. In one embodiment of the present invention, scaling is facilitated by importing an image and using graphics. As described below, an image file is imported and shown on a working canvas on the display. The user selects two or more points and inputs the actual distance between those points (e.g., 120 feet). The image is imported into the canvas and is presented at the appropriate scale.

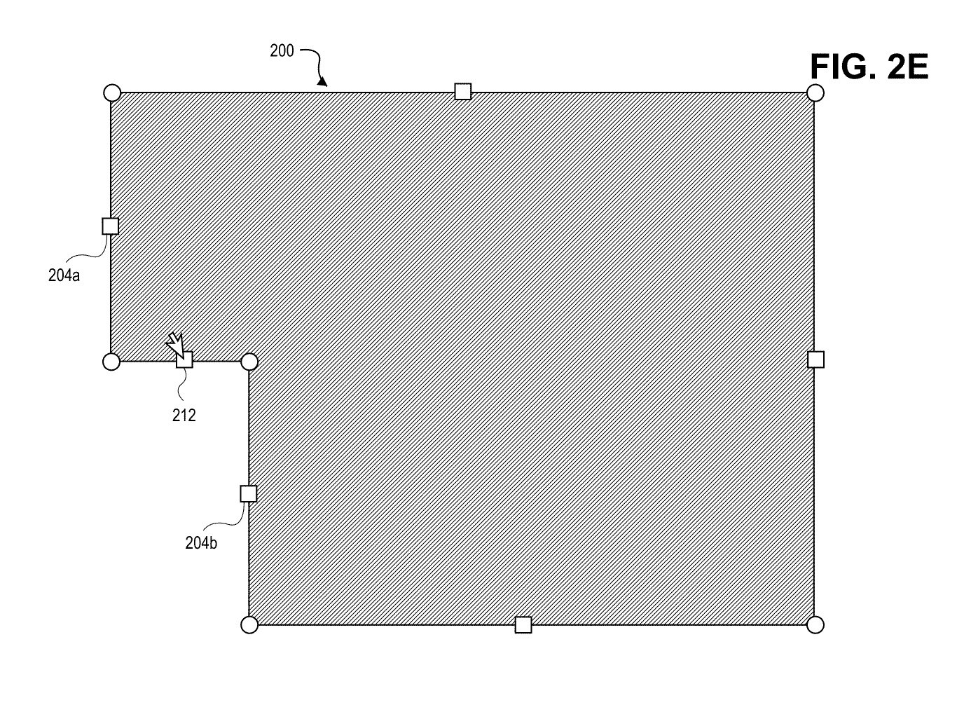

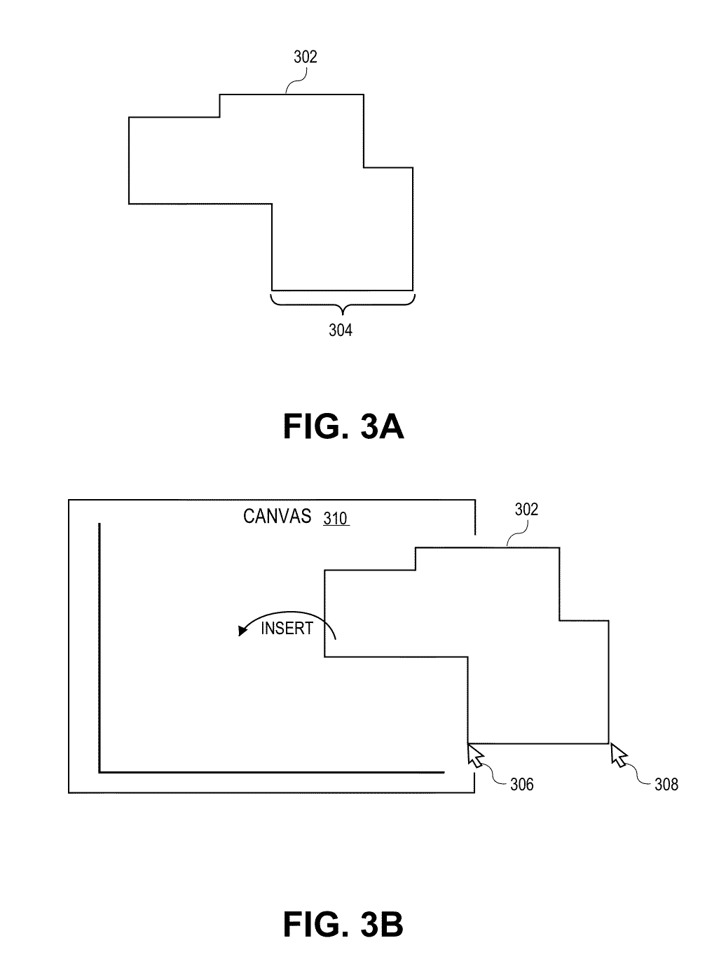

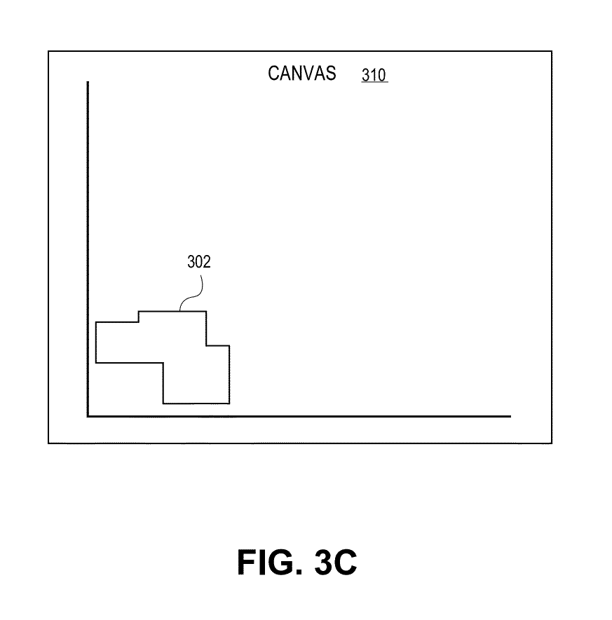

A process of importing a background image into a canvas and scaling the image is shown through a series of screen shots in FIGS. 3A to 3C. FIG. 3A shows a stand-alone, context-free raster or background image 302 selected by the user. This may be an image, for example, of a floor plan that the architect needs to work with. However, in order to incorporate image 302 into a design process, the user needs to import it onto a canvas 310 shown in FIG. 3B and have it scaled correctly relative to the canvas once imported. The user may know the length of at least one dimension of image 302, shown as side 304 having end points 306 and 308.

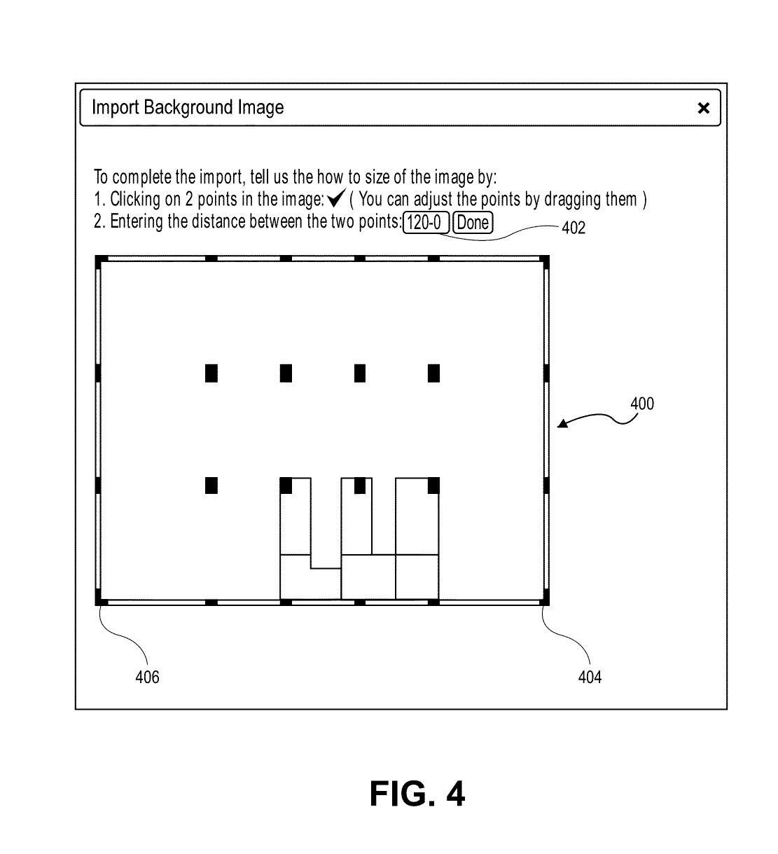

Referring now to FIG. 3B, the user clicks on the two end points (306 and 308) and enters the dimension or length (e.g., 120 ft.) between the two end points in a window in the user interface (shown in FIG. 4 below). The user then imports or inserts background image 302 into canvas 310, essentially a work area with dimensions known to the system and user. It is the relationship between the known dimensions of canvas 310 and the at least one known dimension 304 of background image 302 that enables proper scaling the background image 302. FIG. 3C shows image 302 accurately scaled in canvas 310. This automatic scaling of background images through the selection of two points on the background image of known distance apart, has utility in various stages of Schematic Design and other stages of the architectural process. The user can import as many background images as needed by repeating these steps.

FIG. 4 shows only a background image which the user wants to import onto a canvas (not shown). As noted, the user needs to know at least one dimension of the image. In step 1 of the user interface, the user selects points 404 and 406 (similar to points 306 and 308 in FIG. 3B). At step 2 the user enters the distance, for example in feet and inches, between the points in input field 402.

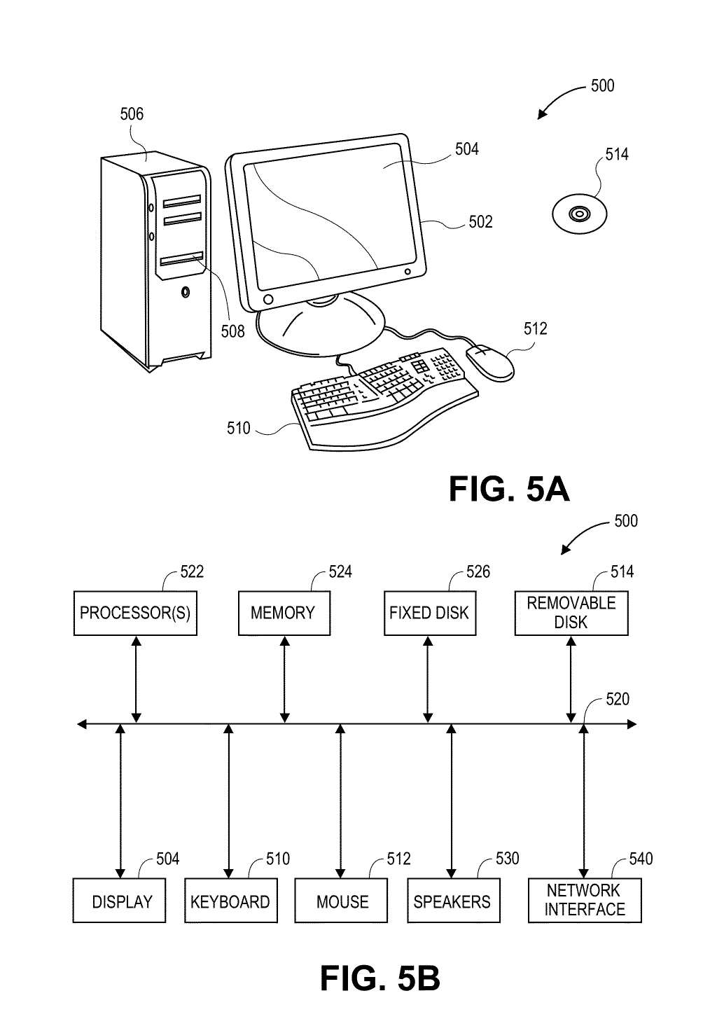

FIGS. 5A and 5B illustrate a computing system 500 suitable for implementing embodiments of the present invention. FIG. 5A shows one possible physical form of the computing system. Of course, the computing system may have many physical forms including an integrated circuit, a printed circuit board, a small handheld device (such as a mobile telephone, handset or PDA), a personal computer or a super computer. Computing system 500 includes a monitor 502, a display 504, a housing 506, a disk drive 508, a keyboard 510 and a mouse 512. Disk 514 is a computer-readable medium used to transfer data to and from computer system 500.

FIG. 5B is an example of a block diagram for computing system 500. Attached to system bus 520 are a wide variety of subsystems. Processor(s) 522 (also referred to as central processing units, or CPUs) are coupled to storage devices including memory 524. Memory 524 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 526 is also coupled bi-directionally to CPU 522; it provides additional data storage capacity and may also include any of the computer-readable media described below. Fixed disk 526 may be used to store programs, data and the like and is typically a secondary storage medium (such as a hard disk) that is slower than primary storage. It will be appreciated that the information retained within fixed disk 526, may, in appropriate cases, be incorporated in standard fashion as virtual memory in memory 524. Removable disk 514 may take the form of any of the computer-readable media described below.

CPU 522 is also coupled to a variety of input/output devices such as display 504, keyboard 510, mouse 512 and speakers 530. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 522 optionally may be coupled to another computer or telecommunications network using network interface 540. With such a network interface, it is contemplated that the CPU might receive information from the network, or might output information to the network in the course of performing the above-described method steps. Furthermore, method embodiments of the present invention may execute solely upon CPU 522 or may execute over a network such as the Internet in conjunction with a remote CPU that shares a portion of the processing.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

What we claim is:

1. A method of facilitating architectural design, the method comprising:
selecting a resource from a resource pool displayed on a monitor;
allocating a portion of the resource to a stacking diagram thereby numerically changing the resource pool and the stacking diagram in real time;
selecting a graphical object to block edit;
bifurcating an edge of the graphical object in a first user interaction; and
editing the edge utilizing an edit point in a second user interaction.

2. A method as recited in claim 1 further comprising:
defining the resource pool as employees and floor space; and
defining the stacking diagram as one or more floors of a building visually represented as a plurality of bar graphs.

3. A method as recited in claim 1 wherein bifurcating an edge further comprises:
selecting the edit point on a perimeter of the graphical object; and
editing the graphical object.

4. A method as recited in claim 1 further comprising:
scaling the graphical object in a visually intuitive manner

5. A method as recited in claim 1 wherein allocating a portion of the resource to a stacking diagram thereby numerically changing the resource pool and the stacking diagram in real time further comprises:
graphically changing the resource pool and the stacking diagram in real time.

6. A method of implementing a user interface for an architectural design tool, the method comprising:
enabling a visual stacking diagram tool including a graphically displayed feeder component and a graphically displayed stacking diagram;
receiving input from a user moving resources from the feeder component to the stacking diagram wherein updates are displayed visually in real time;
enabling a block editing tool wherein the user bifurcates an edge of a graphical object in a first single user interaction and edits the edge in a second single user interaction; and
scaling the graphical object in a third single user interaction wherein scaling is established visually,
wherein stacking and block editing are performed in a manner that is consistent with architectural training.

7. A method as recited in claim 6 further comprising:
entering at least one known dimension of the graphical object, said known dimension utilized in executing a scaling operation and visually establishing said scaling.

8. A method as recited in claim 6 wherein said block editing tool is used to edit one dimensional graphical objects, two dimensional graphical objects, and three dimensional graphical objects.
